(19) United States
(12) Patent Application Publication
(10) Pub. No.: US 2009/0003496 A1
(43) Pub. Date: Jan. 1, 2009

(54) RECEPTION APPARATUS

(76) Inventor: Shinji AMANO, Ikoma-gun (JP)

Correspondence Address: BIRCH STEWART KOLASCH & BIRCH, PO BOX 747, FALLS CHURCH, VA, 22040-0747, US

(21) Appl. No.: 12/058,840

(22) Filed: Mar. 31, 2008

(30) Foreign Application Priority Data
Jun. 27, 2007 (JP) 2007-169195

(51) Int. Cl. H04L 1/00

(52) U.S. Cl. 375/346

(57) ABSTRACT

A reception apparatus is provided with a semiconductor integrated circuit device and a UHF-fixed band-pass filter provided in a stage preceding the semiconductor integrated circuit device. The semiconductor integrated circuit device includes a frequency converter, a to-be-frequency-converted-signal transmission line through which a to-be-frequency-converted signal is fed to the frequency converter, a local-oscillation-signal transmission line through which a local oscillation signal is fed to the frequency converter and an unnecessary-signal attenuation circuit, provided in the to-be-frequency-converted-signal transmission line, that attenuates an unnecessary signal included in signals transmitted through the to-be-frequency-converted-signal transmission line.

This nonprovisional application claims priority under 35 U.S.C. § 119(a) on Patent Application No. 2007-169195 filed in Japan on Jun. 27, 2007, the entire contents of which are hereby incorporated by reference.

### BACKGROUND OF THE INVENTION

1. Field of the Invention

The present invention relates to a reception apparatus provided with a semiconductor integrated circuit device incorporating a frequency converter.

2. Description of Related Art

Reception apparatuses adopt various configurations to have characteristics required for reception. Hereinafter, a reception apparatus for one-segment broadcasting will be described as an example of a conventional reception apparatus. The one-segment broadcasting refers to terrestrial digital broadcasting service for portable devices in Japan.

In FIG. 23, an example of the configuration of a conventional reception apparatus for the one-segment broadcasting is schematically shown. The conventional one-segment broadcasting reception apparatus shown in FIG. 23 is provided with: a UHF-fixed band-pass filter 1 selecting only signals within a reception band (UHF band); a high-frequency amplifier 2; a frequency converter 3; a local oscillation signal generator 4; an IF/BB signal processing circuit 5 including signal processing components such as an amplifier and a filter for limiting the frequency band of an IF signal or BB signed outputted from the frequency converter 3; and a demodulation section 6. A tuner section 100 is composed of the UHF-fixed band-pass filter 1, the high-frequency amplifier 2, the frequency converter 3, the local oscillation signal generator 4 and the IF/BB signal processing circuit 5; the tuner section 100 feeds signals to the demodulation section 6 in the succeeding stage. The high-frequency amplifier 2, the frequency converter 3, the local oscillation signal generator 4 and the IF/BB signal processing circuit 5 are integrated into a semiconductor integrated circuit device 200. Since it is difficult to integrate the UHF-fixed band-pass filter 1 into a semiconductor integrated circuit, the UHF-fixed band-pass filter 1 is externally connected to the semiconductor integrated circuit device 200.

When the tuner section 100, for example, employs the low-IF method where an IF signal is used that has a low frequency, that is, a frequency of less than several megahertz, the frequency of a local oscillation signal is set at a frequency obtained by shifting the frequency of a desired reception signal by the frequency of the IF signal, and the IF/BB signal processing circuit 5 is configured to include signal processing components such as an amplifier and a filter for limiting the frequency band of the IF signal outputted from the frequency converter 3. When the tuner section 100, for example, employs the zero-IF method (direct conversion), the frequency of a local oscillation signal is set at a frequency equal to that of a desired reception signal so that the output signal of the frequency converter 3 becomes a BB signal whose center frequency is zero, and the IF/BB signal processing circuit 5 is configured to include signal processing components such as an amplifier and a filter for limiting the frequency band of the BB signal outputted from the frequency converter 3.

Hereinafter, with reference to FIGS. 24A to 24C and 25, the operation of the conventional one-segment broadcasting reception apparatus shown in FIG. 23 will be described by way of an example where the tuner section 100 employs the low-IF method.

Since the reception band (UHF band) of the one-segment broadcasting spans a wide band ranging from about 470 to 770 MHz, the tuner section 100 receives signals including a large number of signals (interference signals) having unnecessary frequency components outside the reception band (UHF band). The UHF-fixed band-pass filter 1 receives signals inputted to the tuner section 100, and attenuates interference signals included in the input signals (see FIGS. 24A to 24C). FIG. 24A shows signals inputted to the UHF-fixed band-pass filter 1; FIG. 24B shows an example of the filtering characteristic of the UHF-fixed band-pass filter 1; and FIG. 24C shows signals outputted from the UHF-fixed band-pass filter 1. In FIG. 24A, S1 represents reception-band signals included in signals inputted to the tuner section 100, and S2 represents interference signals included in signals inputted to the tuner section 100. In FIG. 24B, FC represents the frequency characteristic of the UHF-fixed band-pass filter 1. In FIG. 24C, S1′ represents reception-band signals included in signals outputted from the UHF-fixed band-pass filter 1, and S2′ represents interference signals outputted from the UHF-fixed band-pass filter 1 after the interference signals have been attenuated in the UHF-fixed band-pass filter 1.

The signal outputted from the UHF-fixed band-pass filter 1 is amplified by the high-frequency amplifier 2 to an appropriate signal level, and is then fed to the frequency converter 3. The frequency converter 3 performs frequency conversion by mixing the signal inputted from the high-frequency amplifier 2 to the frequency converter 3 with the local oscillation signal fed from the local oscillation signal generator 4, and thereby generates the IF signal. In FIG. 25, S_{IF} represents the IF signal outputted from the frequency converter 3, S_{LOC} represents the local oscillation signal fed from the local oscillation signal generator 4 to the frequency converter 3 and S_{IN} represents the desired reception signal included in the signals inputted from the high-frequency amplifier 2 to the frequency converter 3. The IF signal outputted from the frequency converter 3 is subjected to channel selection and signal level adjustment in the IF/BB signal processing circuit 5, and is fed to the demodulation section 6 in the succeeding stage.

Here, consider a case where the conventional one-segment broadcasting reception apparatus shown in FIG. 23 is incorporated in, for example, a mobile phone. The tuner section 100 receives not only broadcast signals for reception but also relatively high-level signals used for communication between mobile phones, and such high-level signals are likely to be interference signals. When 1.5 GHz band signals, for example, are used for communication between mobile phones, the tuner section 100 receives high-level interference signals having a frequency of about 1.5 GHz. Here, when the tuner section 100, for example, receives broadcast signals whose center frequency is 503 MHz, that is, when the center frequency of desired reception signals is 503 MHz, the frequency used for communication between mobile phones is about three times higher than the reception frequency.

When an intermediate frequency (IF) is +500 kHz, the local oscillation frequency is set at 502.5 MHz (=503 MHz-500 MHz). In reality, however, the signals fed to the frequency converter 3 include the third harmonic of the local oscillation signal, that is, a signal having a frequency of 1507.5 MHz (=3×502.5 MHz). This third harmonic and the above-described 1.5 GHz band interference signal are mixed together by the frequency converter 3, and thus the signals outputted from the frequency converters 3 include the IF interference signal appearing at a frequency equal or close to that of the desired IF signal (see FIG. 26). In FIG. 26, S_{IF}_{_{—}}_{D} represents the IF interference signal outputted from the frequency converter 3, S_{LOC}_{_{—}}_{TH} represents the third harmonic of the local oscillation signal and S_{IN}_{_{—}}_{D} represents the 1.5 GHz band interference signal inputted to the frequency converter 3.

In the conventional one-segment broadcasting reception apparatus shown in FIG. 23, it is necessary to significantly attenuate the 1.5 GHz band interference signal SOD with the UHF-fixed band-pass filter 1 in order to reduce the generation of the IF interference signal S_{IF}_{_{—}}_{D}. In order for the UHF-fixed band-pass filter 1 to significantly attenuate the 1.5 GHz band interference signal S_{IN}_{_{—}}_{D}, however, the number of components used in the UHF-fixed band-pass filter 1 needs to be increased. Disadvantageously, this results in increased mounting area, increased cost and other problems. If it is impossible to make a filter that significantly attenuates the 1.5 GHz band interference signal S_{IN}_{_{—}}_{D} without attenuating the desired reception signal S_{IN} at all, the reception performance may be degraded. In order to eliminate such performance degradation, it may be necessary to increase the gain of a high-frequency amplifier, provide an additional high-frequency amplifier or take other actions.

### SUMMARY OF THE INVENTION

An object of the present invention is to provide a reception apparatus that is provided with a semiconductor integrated circuit device incorporating a frequency converter and reduces the effect of interference signals to improve the reception performance without increasing the size of a filer provided in a stage preceding the semiconductor integrated circuit device.

To achieve the above object, according to one aspect of the invention, a reception apparatus includes a semiconductor integrated circuit device and a fixed band-pass filter provided in a stage preceding the semiconductor integrated circuit device. Here, the semiconductor integrated circuit device includes: a frequency converter; a to-be-frequency-converted-signal transmission line through which a to-be-frequency-converted signal is fed to the frequency converter; a local-oscillation-signal transmission line through which a local oscillation signal is fed to the frequency converter; and at least one of a first unnecessary-signal attenuation circuit, provided in the to-be-frequency-converted-signal transmission line, that attenuates an unnecessary signal included in signals transmitted through the to-be-frequency-converted-signal transmission line and a second unnecessary-signal attenuation circuit, provided in the local-oscillation-signal transmission line, that attenuates an unnecessary signal included in signals transmitted through the local-oscillation-signal transmission line.

With such a configuration, a semiconductor integrated circuit device is provided with at least one of a first unnecessary-signal attenuation circuit, provided in the to-be-frequency-converted-signal transmission line, that attenuates an unnecessary signal included in signals transmitted through the to-be-frequency-converted-signal transmission line and a second unnecessary-signal attenuation circuit, provided in the local-oscillation-signal transmission line, that attenuates an unnecessary signal included in signals transmitted through the local-oscillation-signal transmission line. This helps reduce the effect of interference signals within the semiconductor integrated circuit device. Thus, it is possible to reduce the effect of the interference signals to improve the reception performance without increasing the size of a filer provided in a stage preceding the semiconductor integrated circuit device.

The first unnecessary-signal attenuation circuit and/or the second unnecessary-signal attenuation circuit may be a low-pass filter composed of a resistor and a capacitor.

With such a configuration, it is possible to relatively easily obtain the desired attenuation characteristic of the first unnecessary-signal attenuation circuit and/or the second unnecessary-signal attenuation circuit in the semiconductor integrated circuit device, and to make the first unnecessary-signal attenuation circuit and/or the second unnecessary-signal attenuation circuit, without the need for an inductance that occupies a large area of the semiconductor integrated circuit device.

According to another aspect of the invention, the first unnecessary-signal attenuation circuit may be a capacitor having one end thereof connected to the to-be-frequency-converted-signal transmission line and the other end thereof grounded so as to form a shunt, and/or the second unnecessary-signal attenuation circuit may be a capacitor having one end thereof connected to the local-oscillation-signal transmission line and the other end thereof grounded so as to form a shunt.

With such a configuration, it is possible to obtain a low-pass filter having a low-pass filter characteristic determined by the capacitor and the output impedance of the preceding circuit. Thus, it is possible to obtain the desired attenuation characteristic of the first unnecessary-signal attenuation circuit and/or the second unnecessary-signal attenuation circuit in the semiconductor integrated circuit device, and to make the first unnecessary-signal attenuation circuit and/or the second unnecessary-signal attenuation circuit, without the need for an inductance that occupies a large area of the semiconductor integrated circuit device.

The first unnecessary-signal attenuation circuit and/or the second unnecessary-signal attenuation circuit may include an inductor and a capacitor.

With such a configuration, it is possible to anticipate significantly improved interference resistance by the utilization of resonance phenomenon.

It is desirable for the first and second unnecessary-signal attenuation circuits to attenuate the interference signals as much as possible so as to have a better frequency characteristic, but the to-be-frequency-converted signals or local oscillation signals are thereby attenuated. For example, when to-be-frequency-converted signals whose center frequency is 503 MHz are received, it is necessary to attenuate 1.5 GHz interference signals as much as possible. Disadvantageously, however, in a semiconductor integrated circuit device, it is difficult to attenuate the 1.5 GHz signals without attenuating 770 MHz signals at all since the maximum reception frequency is about 770 MHz.

To overcome such a problem, the capacitor may be replaced with a variable capacitor. Moreover, a capacitance control circuit for controlling the capacitance of the variable capacitor may be included.

To overcome such a problem, at least one of a first switch switching between an effective state and an ineffective state of the first unnecessary-signal attenuation circuit and a second switch switching between an effective state and an ineffective state of the second unnecessary-signal attenuation circuit may be provided. The first switch and/or the second switch may be a metal-oxide semiconductor field-effect transistor. The first unnecessary-signal attenuation circuit may be switched to the effective state with the first switch when the frequency of the to-be-frequency-converted signal is low and may be switched to the ineffective state with the first switch when the frequency of the to-be-frequency-converted signal is high, and/or the second unnecessary-signal attenuation circuit may be switched to the effective state with the second switch when the frequency of the local oscillation signal is low and may be switched to the ineffective state with the second switch when the frequency of the local oscillation signal is high.

In the reception apparatus incorporating at least one of the first and second switches, a local oscillation signal generator generating a local oscillation signal transmitted through the local-oscillation-signal transmission line may be provided, the local oscillation signal generator may include a voltage control oscillator varying an oscillation frequency according to the frequency of a desired reception signal that is the to-be-frequency-converted signal transmitted through the to-be-frequency-converted-signal transmission line and the first switch and/or the second switch may be controlled according to the frequency control voltage of the voltage control oscillator. All the local oscillation signal generator may be incorporated into the semiconductor integrated circuit device, part of the local oscillation signal generator may be incorporated into the semiconductor integrated circuit device or all the local oscillation signal generator may be disposed outside of the semiconductor integrated circuit device.

In the reception apparatus incorporating at least one of the first and second switches, a local oscillation signal generator generating a local oscillation signal transmitted through the local-oscillation-signal transmission line may be provided, the local oscillation signal generator may include a plurality of voltage control oscillators and a selection circuit selecting one of the plurality of voltage control oscillators according to the frequency of a desired reception signal that is the to-be-frequency-converted signal transmitted through the to-be-frequency-converted-signal transmission line, the voltage control oscillator selected by the selection circuit may generate an oscillating signal corresponding to the frequency of the desired reception signal and outputs the oscillating signal as the local oscillation signal and the first switch and/or the second switch may be controlled according to selection of the voltage control oscillators by the selection circuit. All the local oscillation signal generator may be incorporated into the semiconductor integrated circuit device, part of the local oscillation signal generator may be incorporated into the semiconductor integrated circuit device or all the local oscillation signal generator may be disposed outside of the semiconductor integrated circuit device.

The reception apparatus according to the present invention is provided with at least one of the first unnecessary-signal attenuation circuit, provided in the to-be-frequency-converted-signal transmission line, that attenuates an unnecessary signal included in signals transmitted through the to-be-frequency-converted-signal transmission line and the second unnecessary-signal attenuation circuit, provided in the local-oscillation-signal transmission line, that attenuates an unnecessary signal included in signals transmitted through the local-oscillation-signal transmission line. This helps reduce the effect of interference signals in the semiconductor integrated circuit device. Thus, it is possible to reduce the effect of the interference signals to improve the reception performance without increasing the size of a filter provided in a stage preceding the semiconductor integrated circuit device.

### BRIEF DESCRIPTION OF THE DRAWINGS

FIG. 1 is a diagram schematically showing the configuration of a one-segment broadcasting reception apparatus according to a first embodiment of the present invention.

FIGS. 2A and 2B are diagrams showing an example of the relationship between signals at the relevant portions of the one-segment broadcasting reception apparatus according to the first embodiment of the invention.

FIG. 3 is a diagram schematically showing the configuration of a one-segment broadcasting reception apparatus according to a second embodiment of the invention.

FIGS. 4A and 4B are diagrams showing an example of the relationship between signals at the relevant portions of the one-segment broadcasting reception apparatus according to the second embodiment of the invention.

FIG. 5 is a diagram showing a conversion gain characteristic of a frequency converter.

FIG. 6 is a diagram schematically showing the configuration of a one-segment broadcasting reception apparatus according to a third embodiment of the invention.

FIGS. 7A and 7B are diagrams showing an example of the relationship between signals at the relevant portions of the one-segment broadcasting reception apparatus according to the third embodiment of the invention.

FIG. 8 is a diagram showing an example of the one-segment broadcasting reception apparatus according to the first embodiment of the invention.

FIG. 9 is a diagram showing an example of the one-segment broadcasting reception apparatus according to the second embodiment of the invention.

FIG. 10 is a diagram showing another example of the one-segment broadcasting reception apparatus according to the first embodiment of the invention.

FIG. 11 is a diagram showing another example of the one-segment broadcasting reception apparatus according to the second embodiment of the invention.

FIG. 12 is a diagram showing still another example of the one-segment broadcasting reception apparatus according to the first embodiment of the invention.

FIG. 13 is a diagram showing still another example of the one-segment broadcasting reception apparatus according to the second embodiment of the invention.

FIG. 14 is a diagram showing yet another example of the one-segment broadcasting reception apparatus according to the first embodiment of the invention.

FIG. 15 is a diagram showing yet another example of the one-segment broadcasting reception apparatus according to the second embodiment of the invention.

FIG. 16 is a diagram showing still yet another example of the one-segment broadcasting reception apparatus according to the first embodiment of the invention.

FIG. 17 is a diagram showing still yet another example of the one-segment broadcasting reception apparatus according to the second embodiment of the invention.

FIG. 18 is a diagram showing an example of a one-segment broadcasting reception apparatus according to a third embodiment of the invention.

FIG. 19 is a diagram schematically showing the configuration of a one-segment broadcasting reception apparatus according to a fourth embodiment of the invention.

FIG. 20 is a diagram showing an example of the one-segment broadcasting reception apparatus according to the fourth embodiment of the invention.

FIG. 21 is a diagram showing a specific example of the configuration shown in FIG. 20.

FIG. 22 is a diagram showing another specific example of the configuration shown in FIG. 20.

FIG. 23 is a diagram schematically showing the configuration of a conventional one-segment broadcasting reception apparatus.

FIGS. 24A to 24C are diagrams showing input and output signals and the filtering characteristic of a UHF-fixed band-pass filter.

FIG. 25 is a diagram showing an example of the relationship between signals at the relevant portions of the conventional one-segment broadcasting reception apparatus.

FIG. 26 is a diagram showing an example of the relationship between signals at the relevant portions of the conventional one-segment broadcasting reception apparatus.

### DETAILED DESCRIPTION OF PREFERRED EMBODIMENTS

Hereinafter, embodiments of the present invention will be described with reference to the accompanying drawings. A reception apparatus for one-segment broadcasting will be described herein as an example of a reception apparatus according to the invention.

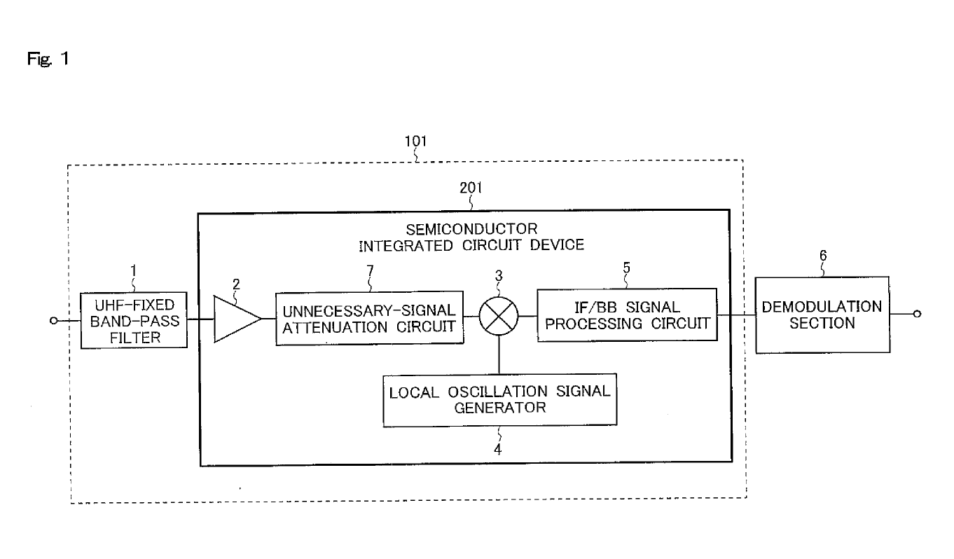

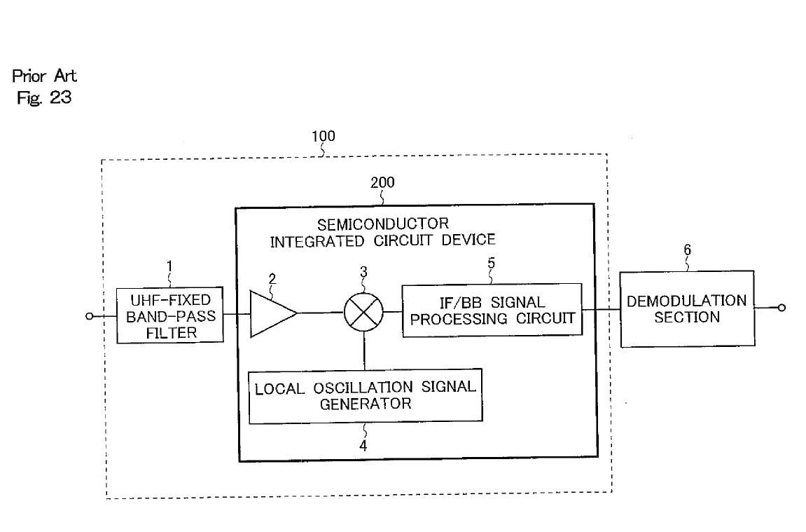

In FIG. 1, the configuration of a one-segment broadcasting reception apparatus according to a first embodiment of the invention is schematically shown. In FIG. 1, such parts as are found also in FIG. 23 are identified with common reference numerals, and no detailed description thereof will be repeated.

The one-segment broadcasting reception apparatus shown in FIG. 1 according to the first embodiment of the invention differs from a conventional one-segment broadcasting reception apparatus shown in FIG. 23 in that it further includes an unnecessary-signal attenuation circuit 7 between a high-frequency amplifier 2 and a frequency converter 3. A tuner section 101 is composed of a UHF-fixed band-pass filter 1, the high-frequency amplifier 2, the frequency converter 3, a local oscillation signal generator 4, an IF/BB signal processing circuit 5 and the unnecessary-signal attenuation circuit 7. The high-frequency amplifier 2, the frequency converter 3, the local oscillation signal generator 4, the IF/BB signal processing circuit 5 and the unnecessary-signal attenuation circuit 7 are integrated into a semiconductor integrated circuit device 201.

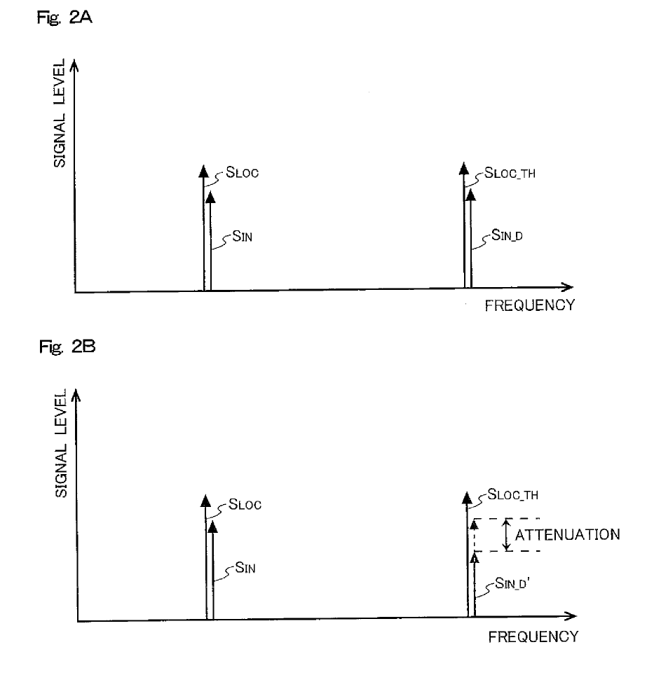

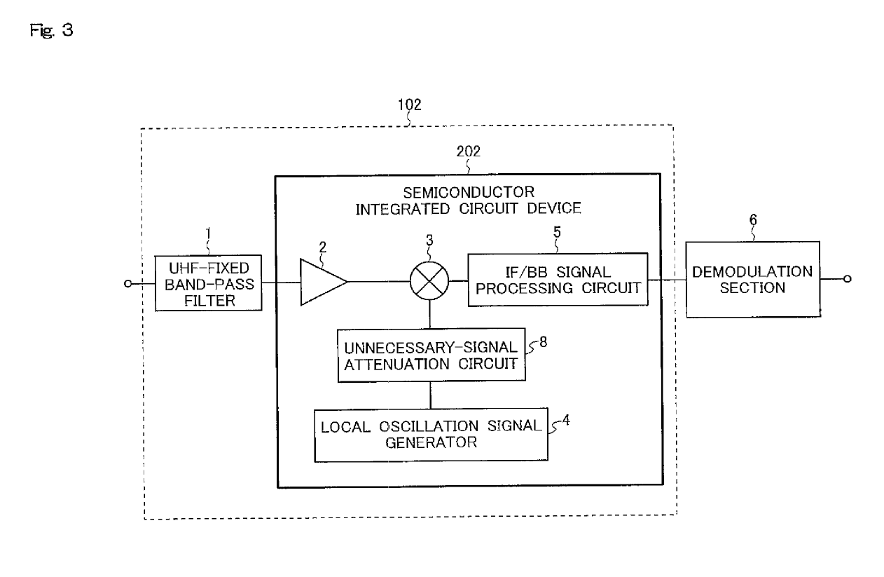

The tuner section 101 that employs the low-IF method and an intermediate frequency (IF) of +500 kHz is taken as an example; an example of the relationship between signals at the relevant portions of the one-segment broadcasting reception apparatus shown in FIG. 1 according to the first embodiment of the invention is shown in FIGS. 2A and 2B.

FIG. 2A shows the relationship between a 502.5 MHz local oscillation signal S_{LOC} fed from the local oscillation signal generator 4 to the frequency converter 3, a desired reception signal S_{IN}, whose center frequency is 503 MHz, inputted from the high-frequency amplifier 2 to the frequency converter 3 through the unnecessary-signal attenuation circuit 7, a third harmonic S_{LOC}_{_{—}}_{TH} of the local oscillation signal and a 1.5 GHz band interference signal S_{IN}_{_{—}}_{D} inputted from the high-frequency amplifier 2 to the unnecessary-signal attenuation circuit 7.

FIG. 2B shows the relationship between the 502.5 MHz local oscillation signal S_{LOC} fed from the local oscillation signal generator 4 to the frequency converter 3, the desired reception signal S_{IN}, whose center frequency is 503 MHz, inputted from the high-frequency amplifier 2 to the frequency converter 3 through the unnecessary-signal attenuation circuit 7, the third harmonic S_{LOC}_{_{—}}_{TH} of the local oscillation signal and a 1.5 GHz band interference signal S_{IN}_{_{—}}_{D}′ inputted from the unnecessary-signal attenuation circuit 7 to the frequency converter 3. With the provision of the unnecessary-signal attenuation circuit 7, the 1.5 GHz band interference signal S_{IN}_{_{—}}_{D}′ inputted from the unnecessary-signal attenuation circuit 7 to the frequency converter 3 is attenuated more than the 1.50 Hz band interference signal S_{IN}_{_{—}}_{D} inputted from the high-frequency amplifier 2 to the unnecessary-signal attenuation circuit 7. Hence, since the 1.5 GHz band interference signal S_{IN}_{_{—}}_{D} included in signals outputted from the high-frequency amplifier 2 is attenuated by the unnecessary-signal attenuation circuit 7, the level of the IF interference signal included in signals outputted from the frequency converter 3 is reduced. Thus, in the semiconductor integrated circuit device 201 included in the one-segment broadcasting reception apparatus shown in FIG. 1 according to the first embodiment of the present invention, it is possible to reduce the effect of the interference signals to improve the reception performance without increasing the size of a filter that is externally connected to the input side thereof.

In FIG. 3, the configuration of a one-segment broadcasting reception apparatus according to a second embodiment of the invention is schematically shown. In FIG. 3, such parts as are found also in FIG. 23 are identified with common reference numerals, and no detailed description thereof will be repeated.

The one-segment broadcasting reception apparatus shown in FIG. 3 according to the second embodiment of the invention differs from the conventional one-segment broadcasting reception apparatus shown in FIG. 23 in that it further includes an unnecessary-signal attenuation circuit 8 between the local oscillation signal generator 4 and the frequency converter 3. A tuner section 102 is composed of the UHF-fixed band-pass filter 1, the high-frequency amplifier 2, the frequency converter 3, the local oscillation signal generator 4, the IF/BB signal processing circuit 5 and the unnecessary-signal attenuation circuit 8. The high-frequency amplifier 2, the frequency converter 3, the local oscillation signal generator 4, the IF/BB signal processing circuit 5 and the unnecessary-signal attenuation circuit 8 are integrated into a semiconductor integrated circuit device 202.

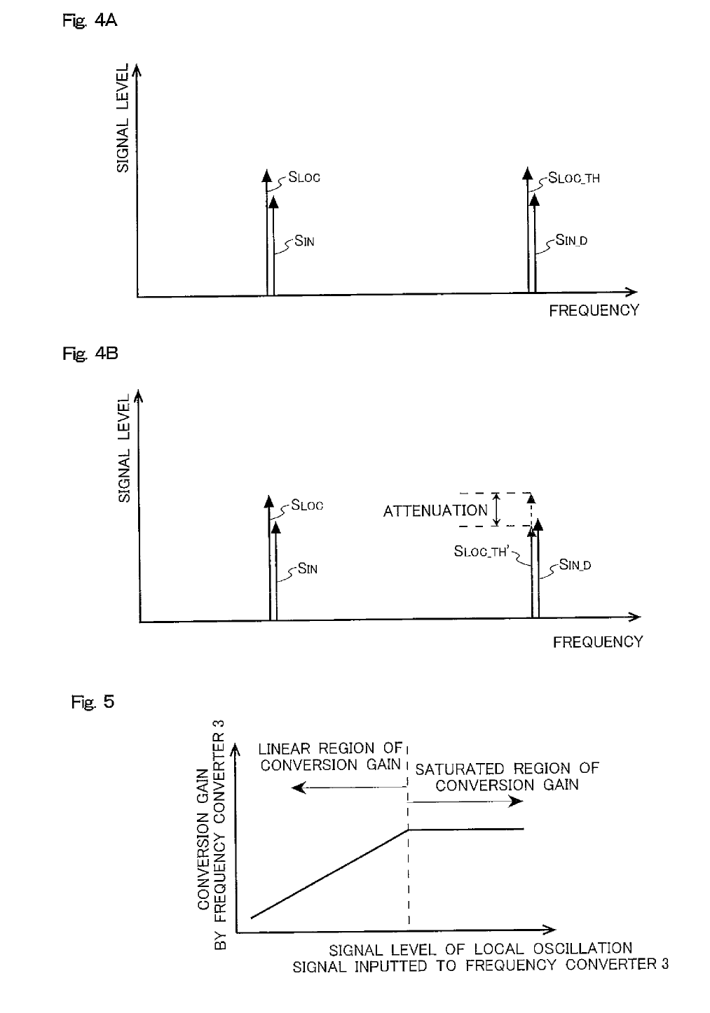

The tuner section 102 that employs the low-IF method and an intermediate frequency (IF) of +500 kHz is taken as an example; an example of the relationship between signals at the relevant portions of the one-segment broadcasting reception apparatus shown in FIG. 3 according to the second embodiment of the invention is shown in FIGS. 4A and 4B.

FIG. 4A shows the relationship between the 502.5 MHz local oscillation signal S_{LOC} fed from the local oscillation signal generator 4 to the frequency converter 3 through the unnecessary-signal attenuation circuit 8, the desired reception signal S_{IN}, whose center frequency is 503 MHz, inputted from the high-frequency amplifier 2 to the frequency converter 3, the third harmonic S_{LOC}_{_{—}}_{TH} of the local oscillation signal inputted from the local oscillation signal generator 4 to the unnecessary-signal attenuation circuit 8 and the 1.5 GHz band interference signal S_{IN}_{_{—}}_{D} inputted from the high-frequency amplifier 2 to the frequency converter 3.

FIG. 4B shows the relationship between the 502.5 MHz local oscillation signal S_{LOC} fed from the local oscillation signal generator 4 to the frequency converter 3 through the unnecessary-signal attenuation circuit 8, the desired reception signal S_{IN}, whose center frequency is 503 MHz, inputted from the high-frequency amplifier 2 to the frequency converter 3, a third harmonic S_{LOC}_{_{—}}_{TH}′ of the local oscillation signal inputted from the unnecessary-signal attenuation circuit 8 to the frequency converter 3 and the 1.5 GHz band interference signal S_{IN}_{_{—}}_{D} inputted from the high-frequency amplifier 2 to the frequency converter 3. With the provision of the unnecessary-signal attenuation circuit 8, the third harmonic S_{LOC}_{_{—}}_{TH}′ of the local oscillation signal inputted from the unnecessary-signal attenuation circuit 8 to the frequency converter 3 is attenuated more than the third harmonic S_{LOC}_{_{—}}_{TH} of the local oscillation signal inputted from the local oscillation signal generator 4 to the unnecessary-signal attenuation circuit 8. Hence, since the third harmonic S_{LOC}_{_{—}}_{TH} of the local oscillation signal included in signals outputted from the local oscillation signal generator 4 is attenuated by the unnecessary-signal attenuation circuit 8, the level of the IF interference signal included in signals outputted from the frequency converter 3 is reduced. In particular, when the 1.5 GHz band interference signal S_{IN}_{_{—}}_{D} inputted from the high-frequency amplifier 2 to the frequency converter 3 is mixed in the frequency converter 3 with the third harmonic S_{LOC}_{_{—}}_{TH}′ of the local oscillation signal inputted from the unnecessary-signal attenuation circuit 8 to the frequency converter 3 and if the conversion gain of the frequency converter 3 falls within the linear region shown in FIG. 5, the level of the IF interference signal included in signals outputted from the frequency converter 3 is reduced according to the attenuation level by the unnecessary-signal attenuation circuit 8. Thus, in the semiconductor integrated circuit device 202 included in the one-segment broadcasting reception apparatus shown in FIG. 3 according to the second embodiment of the present invention, it is possible to reduce the effect of the interference signals to improve the reception performance without increasing the size of a filter that is externally connected to the input side thereof.

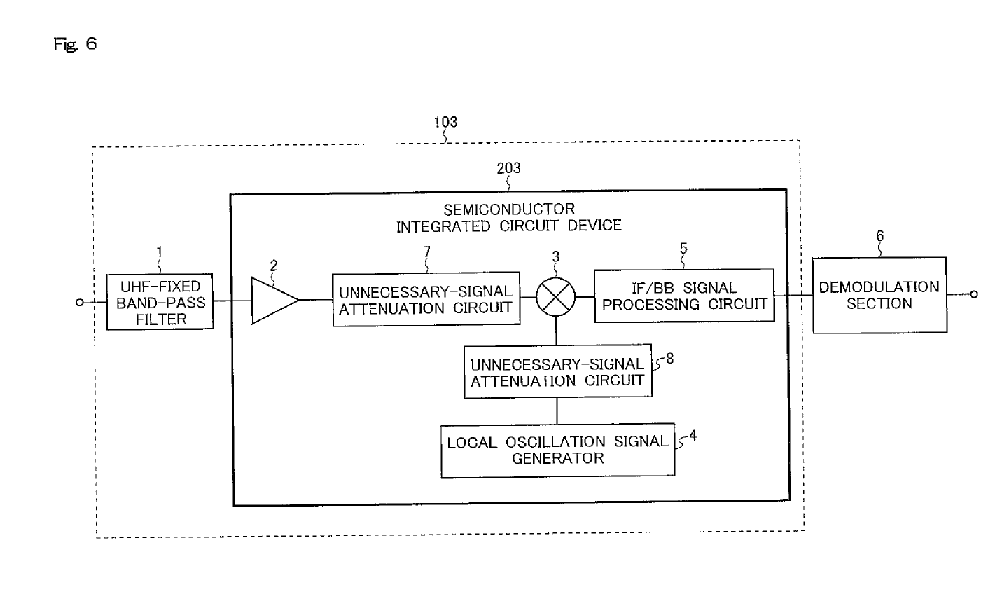

In FIG. 6, the configuration of a one-segment broadcasting reception apparatus according to a third embodiment of the invention is schematically shown. In FIG. 6, such parts as are found also in FIG. 23 are identified with common reference numerals, and no detailed description thereof will be repeated.

The one-segment broadcasting reception apparatus shown in FIG. 6 according to the third embodiment of the invention differs from the conventional one-segment broadcasting reception apparatus shown in FIG. 23 in that it further includes both the unnecessary-signal attenuation circuit 7 between the high-frequency amplifier 2 and the frequency converter 3 and the unnecessary-signal attenuation circuit 8 between the local oscillation signal generator 4 and the frequency converter 3. A tuner section 103 is composed of the UHF-fixed band-pass filter 1, the high-frequency amplifier 2, the frequency converter 3, the local oscillation signal generator 4, the IF/BB signal processing circuit 5 and the unnecessary-signal attenuation circuits 7 and 8. The high-frequency amplifier 2, the frequency converter 3, the local oscillation signal generator 4, the IF/BB signal processing circuit 5 and the unnecessary-signal attenuation circuits 7 and 8 are integrated into a semiconductor integrated circuit device 203.

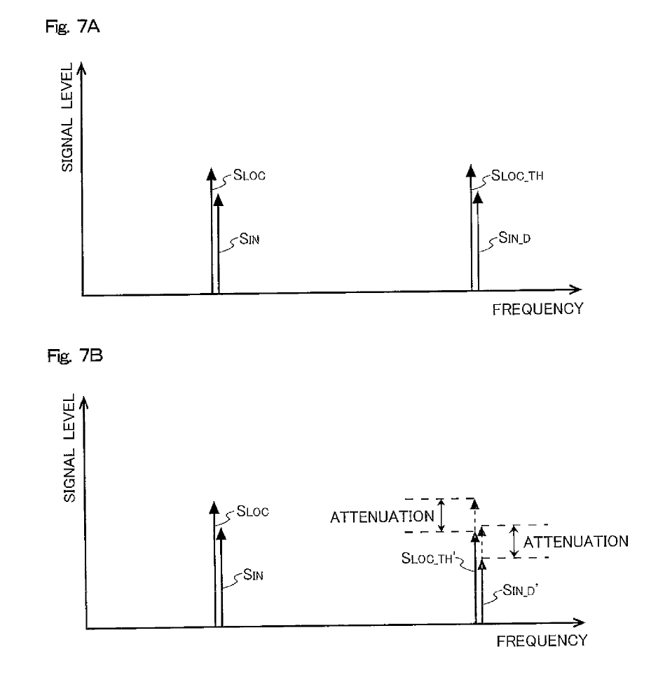

The tuner section 103 that employs the low-IF method and an intermediate frequency (IF) of +500 kHz is taken as an example; an example of the relationship between signals at the relevant portions of the one-segment broadcasting reception apparatus shown in FIG. 6 according to the third embodiment of the invention is shown in FIGS. 7A and 7B.

FIG. 7A shows the relationship between the 502.5 MHz local oscillation signal S_{LOC} fed from the local oscillation signal generator 4 to the frequency converter 3 through the unnecessary-signal attenuation circuit 8, the desired reception signal S_{IN}, whose center frequency is 503 MHz, inputted from the high-frequency amplifier 2 to the frequency converter 3 through the unnecessary-signal attenuation circuit 7, the third harmonic S_{LOC}_{_{—}}_{TH} of the local oscillation signal inputted from the local oscillation signal generator 4 to the unnecessary-signal attenuation circuit 8 and the 1.5 GHz band interference signal S_{IN}_{_{—}}_{D} inputted from the high-frequency amplifier 2 to the unnecessary-signal attenuation circuit 7.

FIG. 7B shows the relationship between the 502.5 MHz local oscillation signal S_{LOC} fed from the local oscillation signal generator 4 to the frequency converter 3 through the unnecessary-signal attenuation circuit 8, the desired reception signal S_{IN}, whose center frequency is 503 MHz, inputted from the high-frequency amplifier 2 to the frequency converter 3 through the unnecessary-signal attenuation circuit 7, the third harmonic S_{LOC}_{_{—}}_{TH}′ of the local oscillation signal inputted from the unnecessary-signal attenuation circuit 8 to the frequency converter 3 and the 1.5 GHz band interference signal S_{IN}_{_{—}}_{D}′ inputted from the unnecessary-signal attenuation circuit 7 to the frequency converter 3. With the provision of the unnecessary-signal attenuation circuit 7, the 1.5 GHz band interference signal S_{IN}_{_{—}}_{D}′ inputted from the unnecessary-signal attenuation circuit 7 to the frequency converter 3 is attenuated more than the 1.5 GHz band interference signal S_{IN}_{_{—}}_{D} inputted from the high-frequency amplifier 2 to the unnecessary-signal attenuation circuit 7. With the provision of the unnecessary-signal attenuation circuit 8, the third harmonic S_{LOC}_{_{—}}_{TH}′ of the local oscillation signal inputted from the unnecessary-signal attenuation circuit 8 to the frequency converter 3 is attenuated more than the third harmonic S_{LOC}_{_{—}}_{TH} of the local oscillation signal inputted from the local oscillation signal generator 4 to the unnecessary-signal attenuation circuit 8. Hence, since the 1.5 GHz band interference signal S_{IN}_{_{—}}_{D} included in signals outputted from the high-frequency amplifier 2 is attenuated by the unnecessary-signal attenuation circuit 7, and the third harmonic S_{LOC}_{_{—}}_{TH} of the local oscillation signal included in signals outputted from the local oscillation signal generator 4 is attenuated by the unnecessary-signal attenuation circuit 8, the level of the IF interference signal included in signals outputted from the frequency converter 3 is reduced as compared with the first and second embodiments. Thus, in the semiconductor integrated circuit device 203 included in the one-segment broadcasting reception apparatus shown in FIG. 6 according to the third embodiment of the present invention, it is possible to reduce the effect of the interference signals to improve the reception performance, as compared with the first and second embodiments, without increasing the size of a filter that is externally connected to the input side thereof.

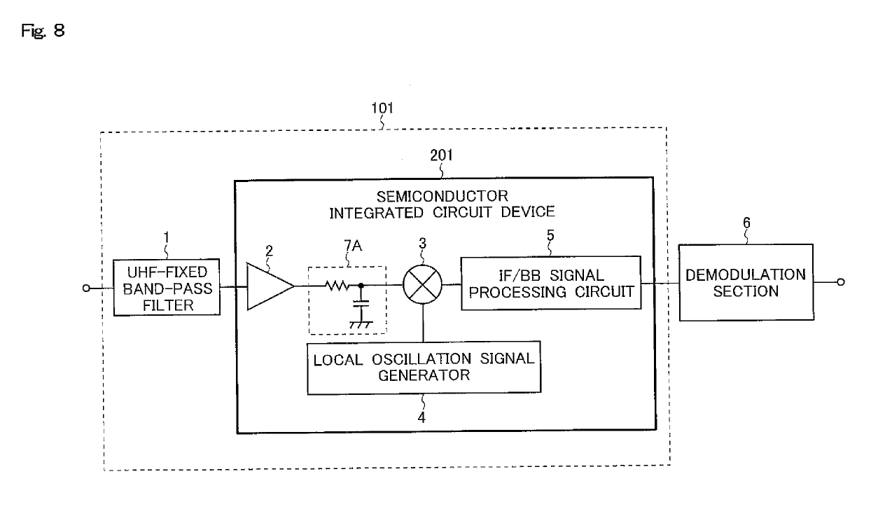

An example of the one-segment broadcasting reception apparatus according to the first embodiment of the invention is shown in FIG. 8. In FIG. 8, a low-pass filter 7A composed of a resistor and a capacitor is used as the unnecessary-signal attenuation circuit 7 (see FIG. 1). The frequency characteristic of the low-pass filter 7A is so designed that the low-pass filter 7A passes the desired reception signal S_{IN} (see FIG. 2A) whose center frequency is 503 MHz while attenuating it as little as possible but attenuating the 1.50 Hz band interference signal S_{IN}_{_{—}}_{D} (see FIG. 2A) as much as possible. In this way, it is possible to reduce the level of the IF interference signal included in signals outputted from the frequency converter 3.

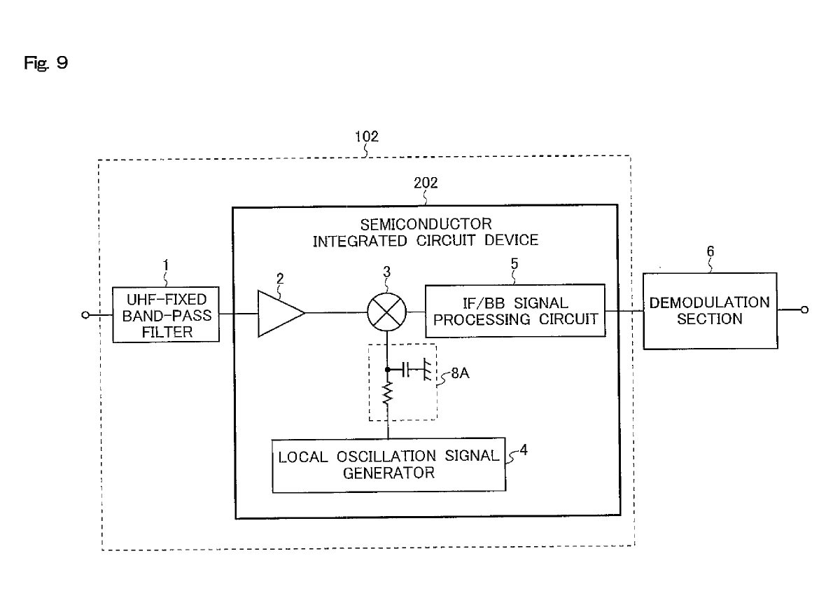

An example of the one-segment broadcasting reception apparatus according to the second embodiment of the invention is shown in FIG. 9. In FIG. 9, a low-pass filter 8A composed of a resistor and a capacitor is used as the unnecessary-signal attenuation circuit 8 (see FIG. 3). The frequency characteristic of the low-pass filter 8A is so designed that the low-pass filter 8A passes the 502.5 MHz local oscillation signal S_{LOC} (see FIG. 4A) while attenuating it as little as possible but attenuating the third harmonic S_{LOC}_{_{—}}_{TH} (see FIG. 4A) of the local oscillation signal as much as possible. In this way, it is possible to reduce the level of the IF interference signal included in signals outputted from the frequency converter 3.

With one of the examples of the configurations shown in FIGS. 8 and 9, it is possible to relatively easily obtain the desired attenuation characteristic of the unnecessary-signal attenuation circuit in the semiconductor integrated circuit device, but the transmission loss of the desired reception signal is caused by the resistor of the low-pass filter. Thus, it is necessary to design the entire system in consideration of such transmission loss.

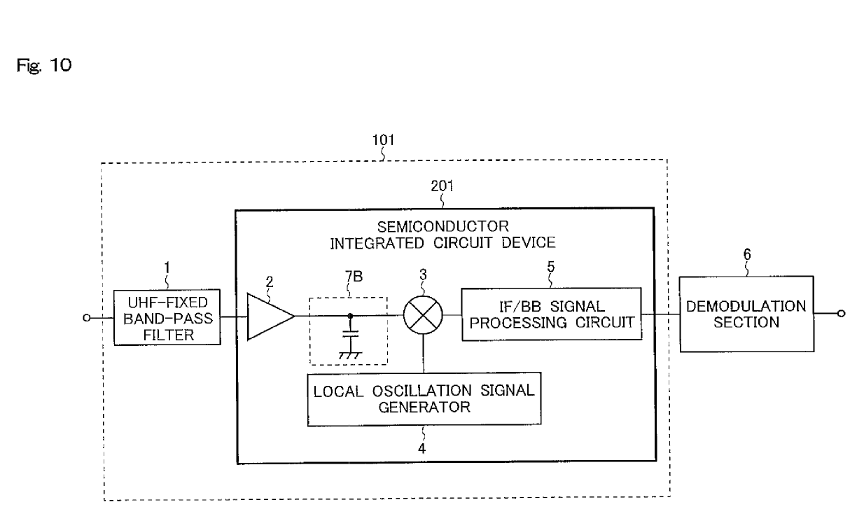

Another example of the one-segment broadcasting reception apparatus according to the first embodiment of the invention is shown in FIG. 10. In FIG. 10, a capacitor 7B having one end thereof connected between the high-frequency amplifier 2 and the frequency converter 3 and the other end thereof grounded so as to form a shunt is used as the unnecessary-signal attenuation circuit 7 (see FIG. 1). Thus, it is possible to obtain a low-pass filter having a low-pass filter characteristic determined by the output impedance of the high-frequency amplifier 2 and the capacitance of the capacitor 7B. This low-pass filter characteristic is so designed that the low-pass filter passes the desired reception signal S_{IN} (see FIG. 2A) whose center frequency is 503 MHz while attenuating it as little as possible but attenuating the 1.5 GHz band interference signal S_{IN}_{_{—}}_{D} (see FIG. 2A) as much as possible. In this way, it is possible to reduce the level of the IF interference signal included in signals outputted from the frequency converter 3.

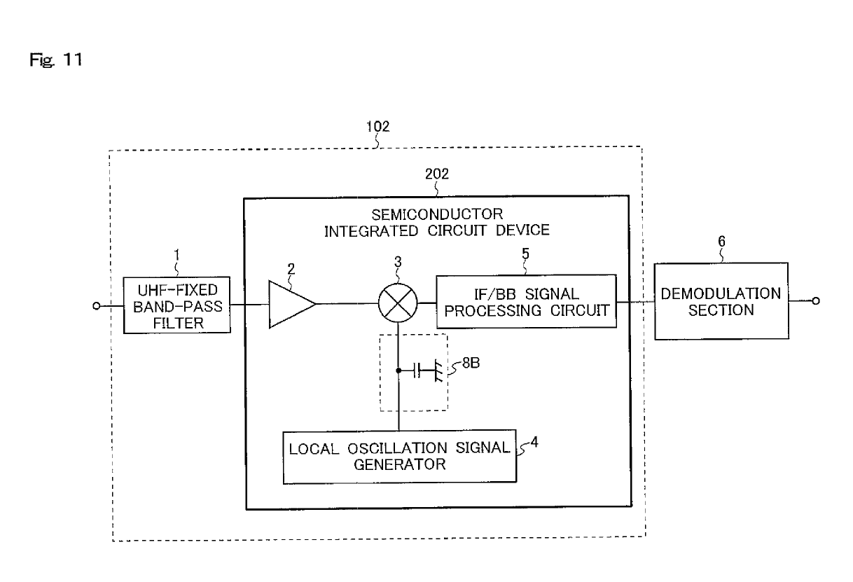

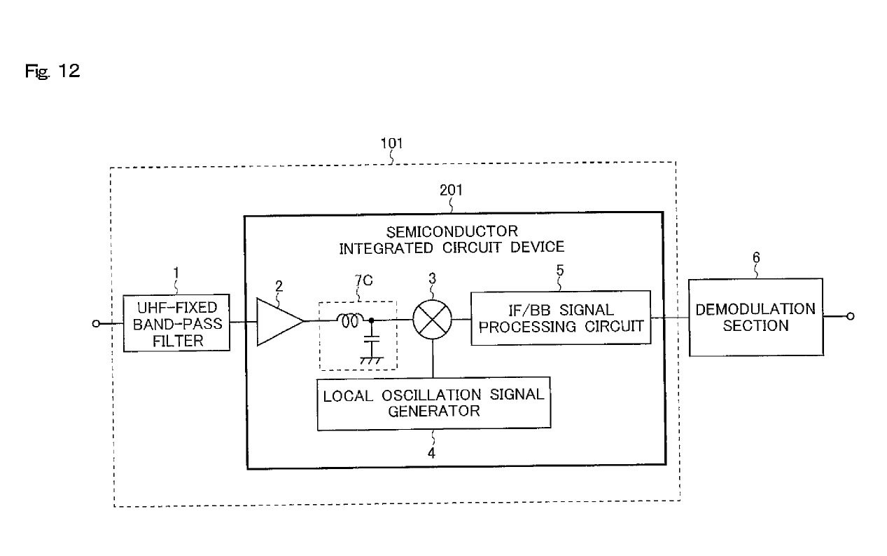

Another example of the one-segment broadcasting reception apparatus according to the second embodiment of the invention is shown in FIG. 11. In FIG. 11, a capacitor 8B having one end thereof connected between the local oscillation signal generator 4 and the frequency converter 3 and the other end thereof grounded so as to form a shunt is used as the unnecessary-signal attenuation circuit 8 (see FIG. 3). Thus, it is possible to obtain a low-pass filter having a low-pass filter characteristic determined by the output impedance of the local oscillation signal generator 4 and the capacitance of the capacitor 8B. This low-pass filter characteristic is so designed that the low-pass filter passes the 502.5 MHz local oscillation signal S_{LOC} (see FIG. 4A) while attenuating it as little as possible but attenuating the third harmonic S_{LOC}_{_{—}}_{TH} (see FIG. 4A) of the local oscillation signal as much as possible. In this way, it is possible to reduce the level of the IF interference signal included in signals outputted from the frequency converter 3.

With one of the examples of the configurations shown in FIGS. 8 to 11, it is possible to make the unnecessary-signal attenuation circuit without the need for an inductor that occupies a large area of the semiconductor integrated circuit device.

Still another example of the one-segment broadcasting reception apparatus according to the first embodiment of the invention is shown in FIG. 12. In FIG. 12, a low-pass filter 7C composed of an inductor and a capacitor is used as the unnecessary-signal attenuation circuit 7 (see FIG. 1). The frequency characteristic of the low-pass filter 7C is so designed that the low-pass filter 7C passes the desired reception signal S_{IN} (see FIG. 2A) whose center frequency is 503 MHz while attenuating it as little as possible but attenuating the 1.5 GHz band interference signal S_{IN}_{_{—}}_{D} (see FIG. 2A) as much as possible. In this way, it is possible to reduce the level of the IF interference signal included in signals outputted from the frequency converter 3.

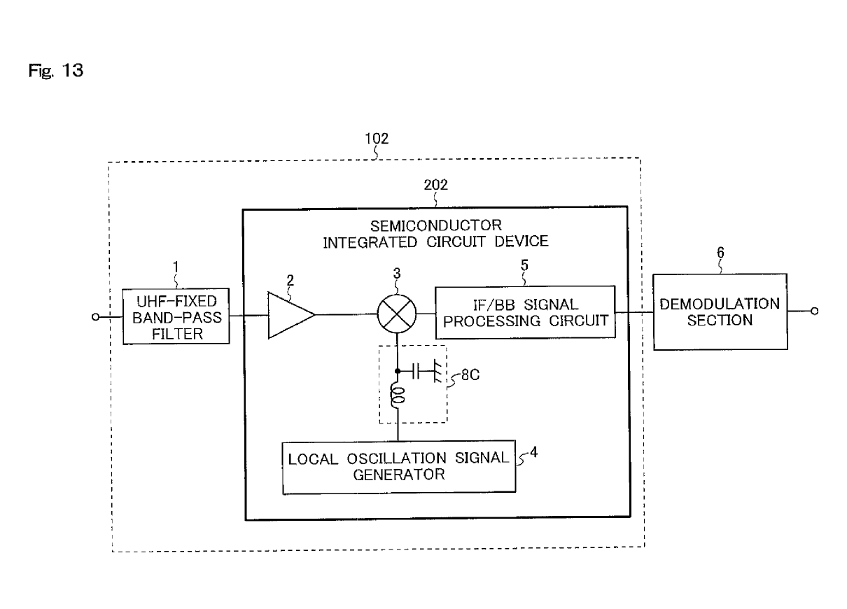

Still another example of the one-segment broadcasting reception apparatus according to the second embodiment of the invention is shown in FIG. 13. In FIG. 13, a low-pass filter 8C composed of an inductor and a capacitor is used as the unnecessary-signal attenuation circuit 8 (see FIG. 3). The frequency characteristic of the low-pass filter 9C is so designed that the low-pass filter 8C passes the 502.5 MHz local oscillation signal S_{LOC} (see FIG. 4A) while attenuating it as little as possible but attenuating the third harmonic S_{LOC}_{_{—}}_{TH} (see FIG. 4A) of the local oscillation signal as much as possible. In this way, it is possible to reduce the level of the IF interference signal included in signals outputted from the frequency converter 3.

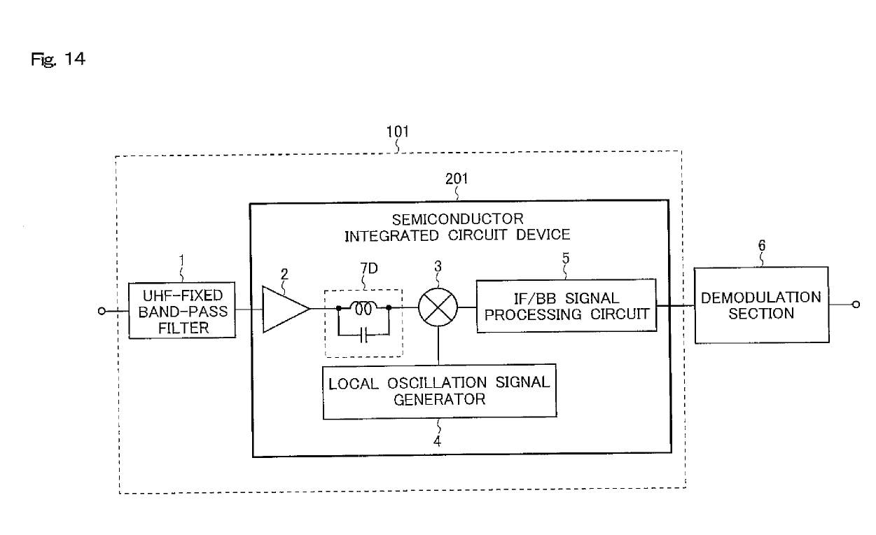

Yet another example of the one-segment broadcasting reception apparatus according to the first embodiment of the invention is shown in FIG. 14. In FIG. 14, a parallel resonant circuit 7D composed of an inductor and a capacitor is used as the unnecessary-signal attenuation circuit 7 (see FIG. 1). The resonant frequency of the parallel resonant circuit 7D is made equal to the frequency of the 1.5 GHz band interference signal S_{IN}_{_{—}}_{D} (see FIG. 2A). Thus, it is possible to significantly reduce the effect of the 1.5 GHz band interference signal. Alternatively, one end of a series resonant circuit composed of an inductor and a capacitor is connected between the high-frequency amplifier 2 and the frequency converter 3 and the other end thereof is grounded so as to form a shunt. In this way, it is possible to obtain the same benefit.

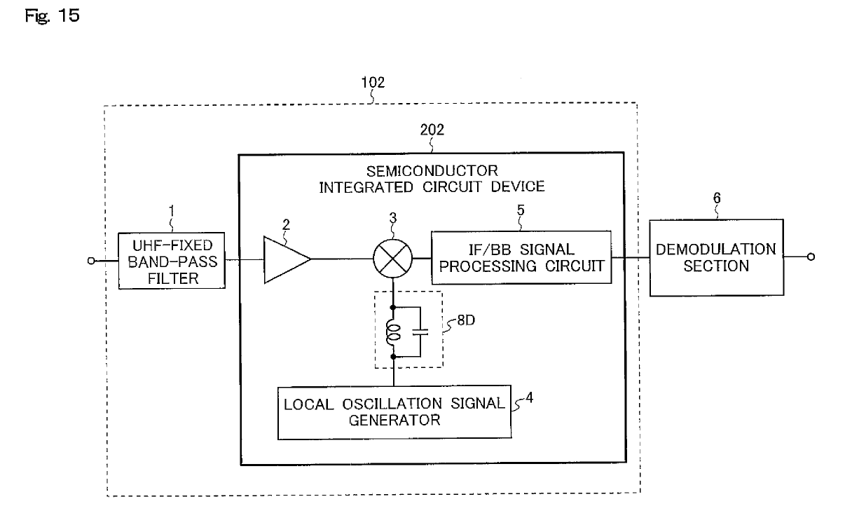

Yet another example of the one-segment broadcasting reception apparatus according to the second embodiment of the invention is shown in FIG. 15. In FIG. 15, a parallel resonant circuit 8D composed of an inductor and a capacitor is used as the unnecessary-signal attenuation circuit 8 (see FIG. 3). The resonant frequency of the parallel resonant circuit SD is made equal to the frequency of the third harmonic S_{LOC}_{_{—}}_{TH} (see FIG. 4A) of the local oscillation signal. Thus, it is possible to significantly reduce the effect of the third harmonic of the local oscillation signal. Alternatively, one end of a series resonant circuit composed of an inductor and a capacitor is connected between the local oscillation signal generator 4 and the frequency converters 3 and the other end thereof is grounded so as to form a shunt. In this way, it is possible to obtain the same benefit.

With one of the examples of the configurations shown in FIGS. 14 and 15, it is possible to anticipate significantly improved interference resistance although the chip area of the semiconductor integrated circuit device is increased since an inductor needs to be formed into the semiconductor integrated circuit device.

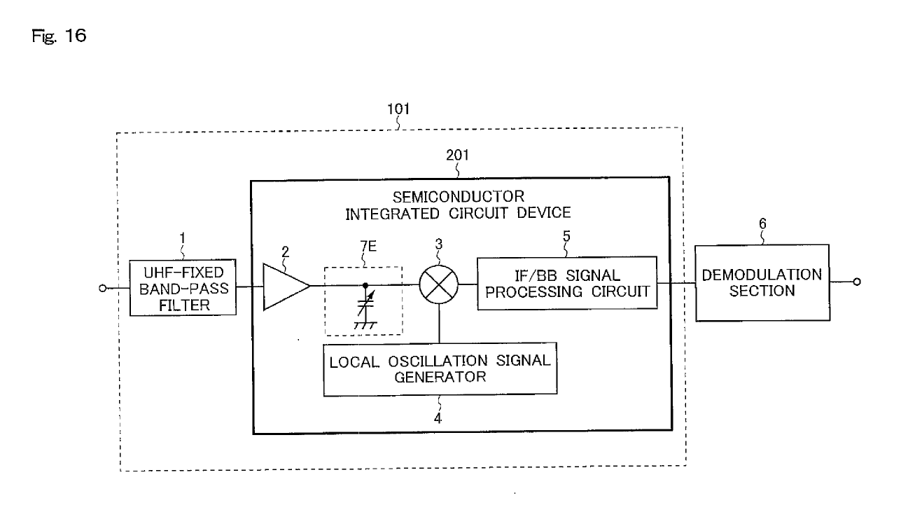

Still yet another example of the one-segment broadcasting reception apparatus according to the first embodiment of the invention is shown in FIG. 16. In FIG. 16, a variable capacitor 7E having one end thereof connected between the high-frequency amplifier 2 and the frequency converter 3 and the other end thereof grounded so as to form a shunt is used as the unnecessary-signal attenuation circuit 7 (see FIG. 1). Thus, it is possible to obtain a low-pass filter having a low-pass filter characteristic determined by the output impedance of the high-frequency amplifier 2 and the capacitance of the variable capacitor 7E. The capacitance of the variable capacitor 7E is appropriately controlled according to the frequency of the desired reception signal. This makes it possible to attenuate the desired reception signal as little as possible when the interference signal included in signals outputted from the high-frequency amplifier 2 is attenuated. For example, in a case where the desired reception signal has a relatively low frequency, the capacitance of the variable capacitor 7E is increased, and thus the interference signal in the high-frequency region is attenuated as much as possible. In this way, it is possible to reduce the level of the IF interference signal. In a case where the desired reception signal has a relatively high frequency, the capacitance of the variable capacitor 7E is deceased, and thus the desired reception signal is attenuated as little as possible. This results in the sufficient reception performance. For example, the semiconductor integrated circuit device 201 may be provided with a capacitance control circuit (not shown in FIG. 16) that controls the capacitance of the variable capacitor 7E. If the center frequency of the desired reception signal is not higher than a predetermined threshold, the capacitance control circuit determines that the desired reception signal has a relatively low frequency, and then increases the capacitance of the variable capacitor 7E from its standard value by a predetermined value. If the center frequency of the desired reception signal is higher than the predetermined threshold, the capacitance control circuit determines that the desired reception signal has a relatively high frequency, and then decreases the capacitance of the variable capacitor 7E from its standard value by a predetermined value.

FIG. 16 is the same as FIG. 10 except that the capacitor is replaced with the variable capacitor. In the cases of FIGS. 8, 12 and 14 (including the case where the series resonant circuit is used that has the same benefit as the parallel resonant circuit 7D of FIG. 14), even when the capacitors are replaced with the variable capacitors, the same benefit can be anticipated.

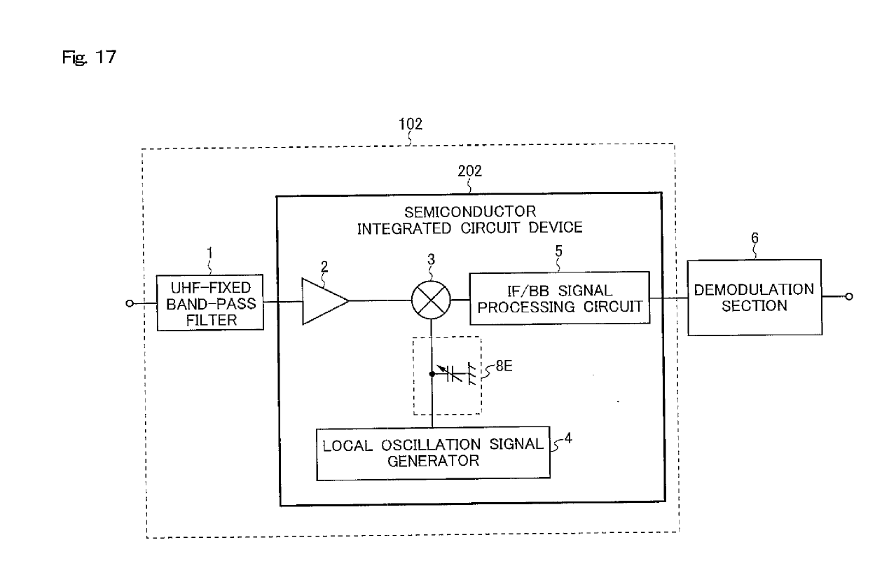

Still yet another example of the one-segment broadcasting reception apparatus according to the second embodiment of the invention is shown in FIG. 17. In FIG. 17, a variable capacitor 8E having one end thereof connected between the local oscillation signal generator 4 and the frequency converter 3 and the other end thereof grounded so as to form a shunt is used as the unnecessary-signal attenuation circuit 8 (see FIG. 3). Thus, it is possible to obtain a low-pass filter having a low-pass filter characteristic determined by the output impedance of the local oscillation signal generator 4 and the capacitance of the variable capacitor 8E. The capacitance of the variable capacitor SE is appropriately controlled according to the frequency of the local oscillation signal. This makes it possible to attenuate the local oscillation signal as little as possible when the third harmonic of the local oscillation signal is attenuated. For example, in a case where a local oscillation signal having a relatively low frequency is needed, the capacitance of the variable capacitor SE is increased, and thus the third harmonic of the local oscillation signal in the high-frequency region is attenuated as much as possible. In this way, it is possible to reduce the level of the IF interference signal. In a case where a local oscillation signal having a relatively high frequency is needed, the capacitance of the variable capacitor 8E is deceased, and thus the local oscillation signal is attenuated as little as possible. This results in the sufficient reception performance. FIG. 17 is the same as FIG. 11 except that the capacitor is replaced with the variable capacitor. In the cases of FIGS. 9, 13 and 15 (including the case where the series resonant circuit is used that has the same benefit as the parallel resonant circuit 8D of FIG. 15), even when the capacitors are replaced with the variable capacitors, the same benefit can be anticipated.

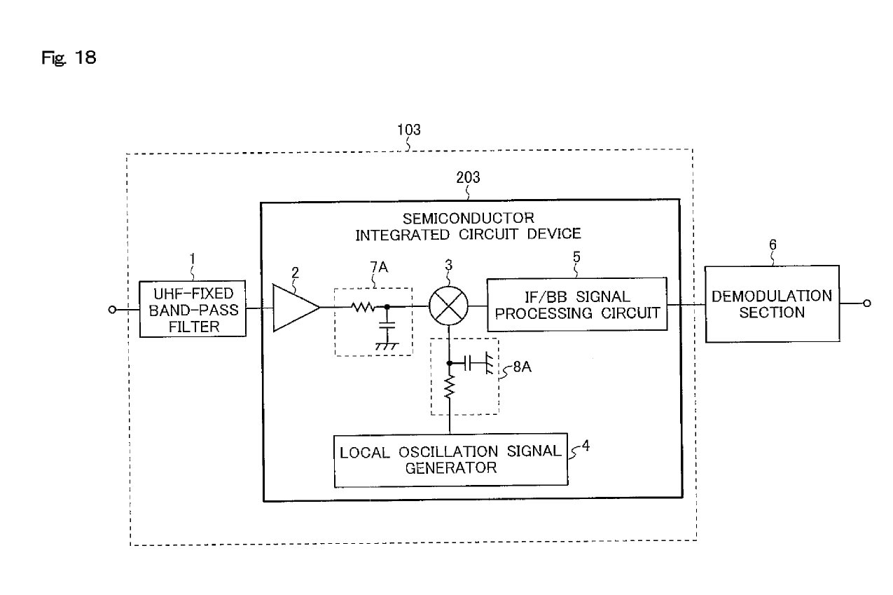

An example of the one-segment broadcasting reception apparatus according to the third embodiment of the invention is shown in FIG. 18. In FIG. 18, a capacitor 7B having one end thereof connected between the high-frequency amplifier 2 and the frequency converter 3 and the other end thereof grounded so as to form a shunt is used as the unnecessary-signal attenuation circuit 7 (see FIG. 6), and a capacitor 8B having one end thereof connected between the local oscillation signal generator 4 and the frequency converter 3 and the other end thereof grounded so as to form a shunt is used as the unnecessary-signal attenuation circuit 8 (see FIG. 6).

Thus, it is possible to obtain a low-pass filter having a low-pass filter characteristic determined by the output impedance of the high-frequency amplifier 2 and the capacitance of the capacitor 7B. This low-pass filter characteristic is so designed that the low-pass filter passes the desired reception signal S_{IN} (see FIG. 7A) whose center frequency is 503 MHz while attenuating it as little as possible but attenuating the 1.5 GHz band interference signal S_{IN}_{_{—}}_{D} (see FIG. 7A) as much as possible. In this way, it is possible to reduce the level of the IF interference signal included in signals outputted from the frequency converter 3. Moreover, it is possible to obtain a low-pass filter having a low-pass filter characteristic determined by the output impedance of the local oscillation signal generator 4 and the capacitance of the capacitor 8B. This low-pass filter characteristic is so designed that the low-pass filter passes the 502.5 MHz local oscillation signal S_{LOC} (see FIG. 7A) while attenuating it as little as possible but attenuating the third harmonic S_{LOC}_{_{—}}_{TH} (see FIG. 7A) of the local oscillation signal as much as possible. In this way, it is possible to reduce the level of the IF interference signal included in signals outputted from the frequency converter 3.

When the capacitors are only used as the unnecessary-signal attenuation circuits as shown in FIG. 18, the output impedances of the circuit (the high-frequency amplifier 2) in a stage preceding the unnecessary-signal attenuation circuit 7 and the circuit (the local oscillation signal generator 4) in a stage preceding the unnecessary-signal attenuation circuit 8 are generally different from each other, and thus the optimum capacitances of the capacitors 7B and 8B are different from each other.

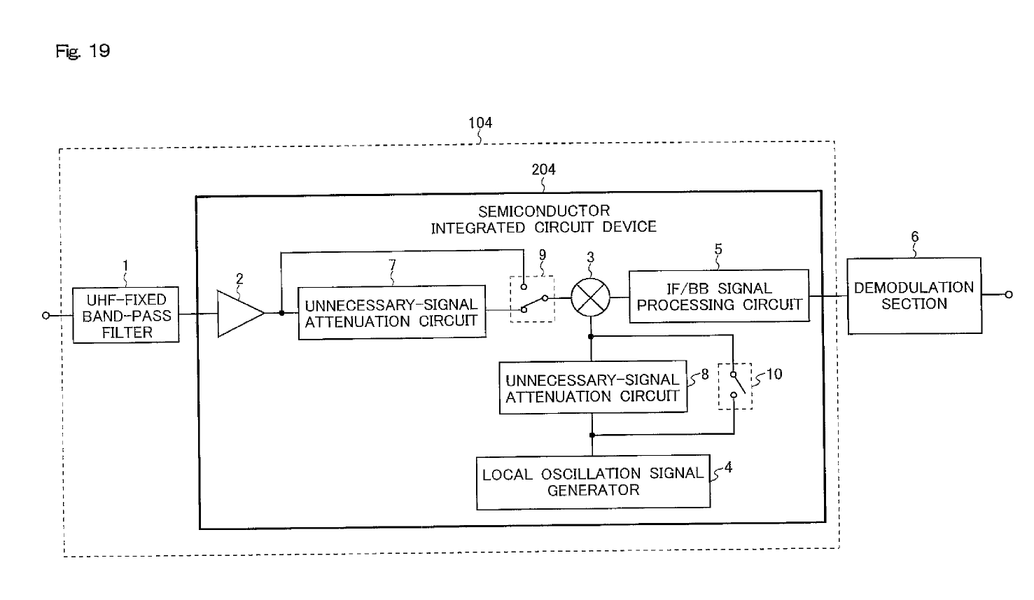

In FIG. 19, the configuration of a one-segment broadcasting reception apparatus according to a fourth embodiment of the invention is schematically shown. In FIG. 19, such parts as are found also in FIG. 6 are identified with common reference numerals, and no detailed description thereof will be repeated.

The one-segment broadcasting reception apparatus shown in FIG. 19 according to the fourth embodiment of the invention differs from the one-segment broadcasting reception apparatus shown in FIG. 6 according to the third embodiment of the invention in that it further includes a switch 9 that switches between the effective state and ineffective state of the unnecessary-signal attenuation circuit 7 for the signal outputted from the high-frequency amplifier 2 and a switch 10 that switches between the effective state and ineffective state of the unnecessary-signal attenuation circuit 8 for the signal outputted from the local oscillation signal generator 4. A tuner section 104 is composed of the UHF-fixed band-pass filter 1, the high-frequency amplifier 2, the frequency converter 3, the local oscillation signal generator 4, the IF/BB signal processing circuit 5, the unnecessary-signal attenuation circuits 7 and 9 and the switches 9 and 10. The high-frequency amplifier 2, the frequency converter 3, the local oscillation signal generator 4, the IF/BB signal processing circuit 5, the unnecessary-signal attenuation circuits 7 and 8 and the switches 9 and 10 are integrated into a semiconductor integrated circuit device 204.

In a case where interference signals included in signals outputted from the high-frequency amplifier 2 always have a frequency higher than desired reception signals included in signals outputted from the high-frequency amplifier 2, the unnecessary-signal attenuation circuit 7 is often configured to have the characteristic of attenuating signals having a frequency higher than desired reception signals included in signals outputted from the high-frequency amplifier 2, that is, to have a low-pass filter characteristic (for example, see FIG. 18). With such a configuration, it is possible to switch, with the switch 9, the unnecessary-signal attenuation circuit 7 to the effective state to attenuate the interference signal when the desired reception signal has a low frequency, and to switch, with the switch 9, the unnecessary-signal attenuation circuit 7 to the ineffective state to prevent the attenuation of the desired reception signal when the desired reception signal has a relatively high frequency.

In a case where the third harmonics of local oscillation signals included in signals outputted from the local oscillation signal generator 4 always have a frequency higher than local oscillation signals included in signals outputted from the local oscillation signal generator 4, the unnecessary-signal attenuation circuit 8 is often configured to have the characteristic of attenuating signals having a frequency higher than local oscillation signals included in signals outputted from the local oscillation signal generator 4, that is, to have a low-pass filter characteristic (for example, see FIG. 18). With such a configuration, it is possible to switch, with the switch 10, the unnecessary-signal attenuation circuit 8 to the effective state to attenuate the third harmonic of the local oscillation signal when the local oscillation signal has a low frequency, and to switch, with the switch 10, the unnecessary-signal attenuation circuit 8 to the ineffective state to prevent the attenuation of the local oscillation signal when the local oscillation signal has a relatively high frequency.

Although the switches 9 and 10 are shown in FIG. 19 to be slightly different from each other, it is not necessarily required to use the switches 9 and 10 shown in FIG. 19. Any switch may be used as long as it is most suitable for the characteristic required for the configuration of the circuit.

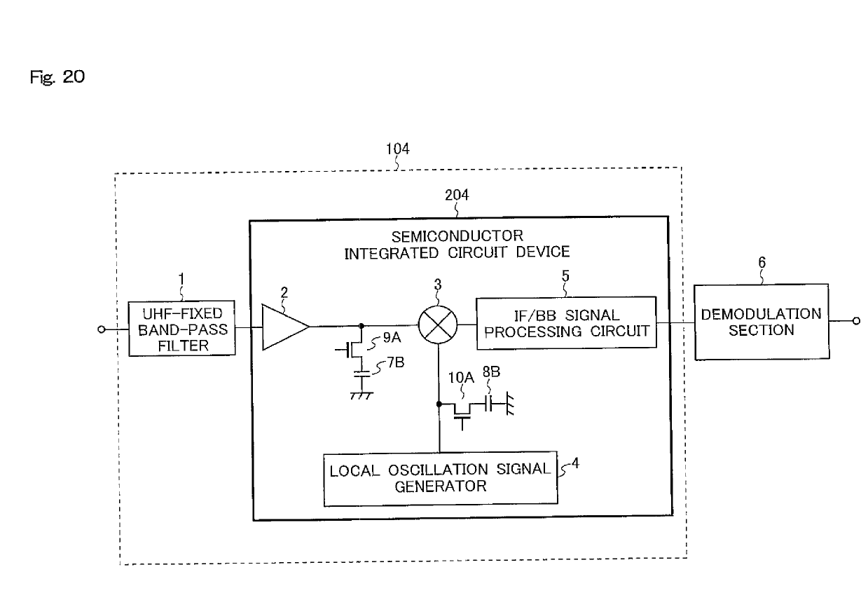

An example of the one-segment broadcasting reception apparatus according to the fourth embodiment of the invention is shown in FIG. 20. In FIG. 20, a field-effect transistor 9A is used as the switch 9 (see FIG. 19), a field-effect transistor 10A is used as the switch 110 (see FIG. 19), a capacitor 7B having one end thereof connected between the high-frequency amplifier 2 and the frequency converter 3 through the Field-effect transistor 9A and the other end thereof grounded so as to form a shunt is used as the unnecessary-signal attenuation circuit 7 (see FIG. 19) and a capacitor 8B having one end thereof connected between the local oscillation signal generator 4 and the frequency converter 3 through the field-effect transistor 10A and the other end thereof grounded so as to form a shunt is used as the in unnecessary-signal attenuation circuit 8 (see FIG. 19).

With such a configuration, it is possible to effectively achieve switching between the effective state and ineffective state of the unnecessary-signal attenuation circuit in the semiconductor integrated circuit. A plurality of series-connected elements composed of the field-effect transistor 9A and the capacitor 7B are connected in parallel, a plurality of series-connected elements composed of the field-effect transistor 10A and the capacitor 8B are connected in parallel and each field-effect transistor is precisely turned on and off according to the frequency of the desired reception signal. In this way, it is possible to attenuate unnecessary signals as much as possible without attenuating the desired reception signal. A control circuit (not shown in FIG. 20) for controlling the turning on and off of each field-effect transistor according to the frequency of the desired reception signal may be disposed within or outside the semiconductor integrated circuit device 204.

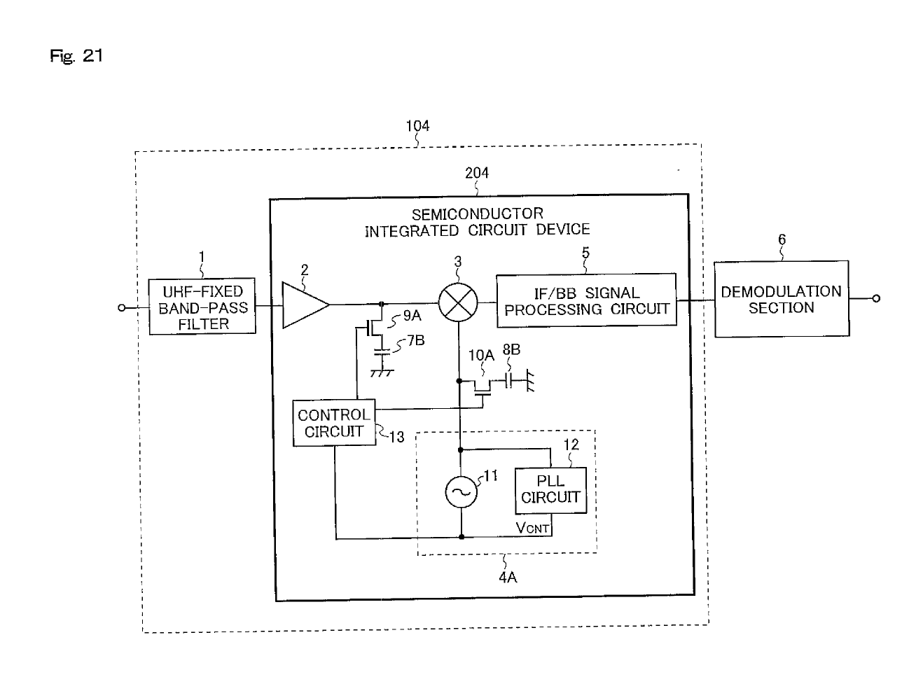

A specific example of the configuration shown in FIG. 20 is shown in FIG. 21. In FIG. 21, a local oscillation signal generator 4A composed of a voltage control oscillator 11 and a PLL circuit 12 that combines with the voltage control oscillator 11 to serve as a PLL is used as the local oscillation signal generator 4 (see FIG. 20). In FIG. 21, a control circuit 13 is included in the semiconductor integrated circuit device 204, a control voltage V_{CNT} fed from the PLL circuit 12 to the voltage control oscillator 11 is also fed to the control circuit 13 and the control circuit 13 turns on and off each of the field-effect transistors 9A and 10A according to the control voltage V_{CNT}. In a reception apparatus employing the low-IF method or the zero-IF method suitable for a semiconductor integrated circuit, the control voltage fed to the voltage control oscillator 11 is varied according to the frequency of the desired reception signal, and the frequency of the local oscillation signal is controlled by the control voltage. Thus, with the configuration shown in FIG. 21, it is possible to control, according to the frequency of the desired reception signal, the switch that switches between the effective state and ineffective state of the unnecessary-signal attenuation circuit.

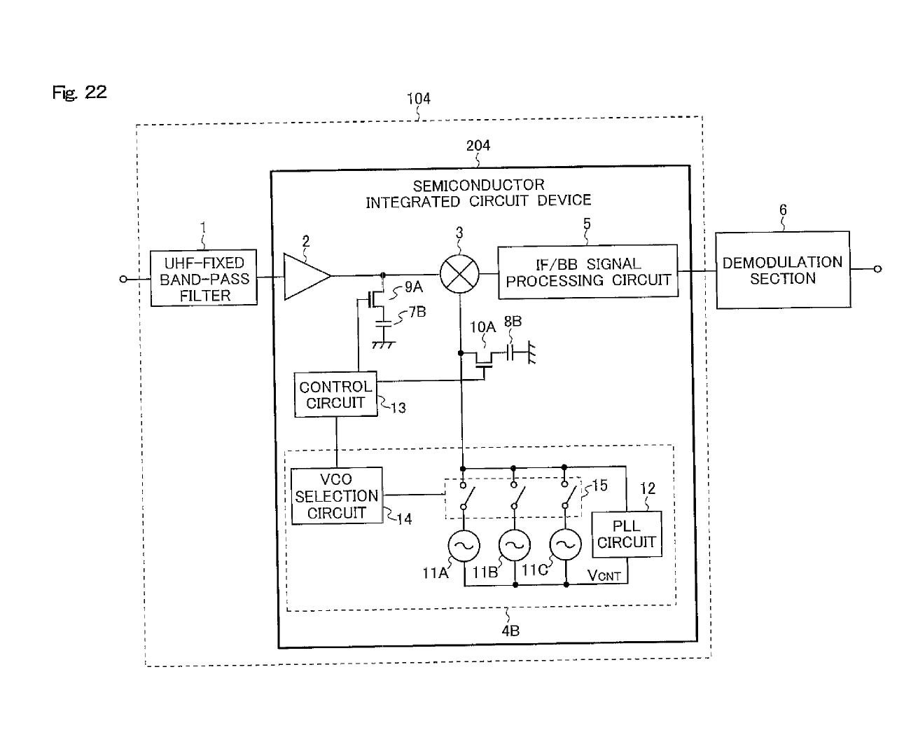

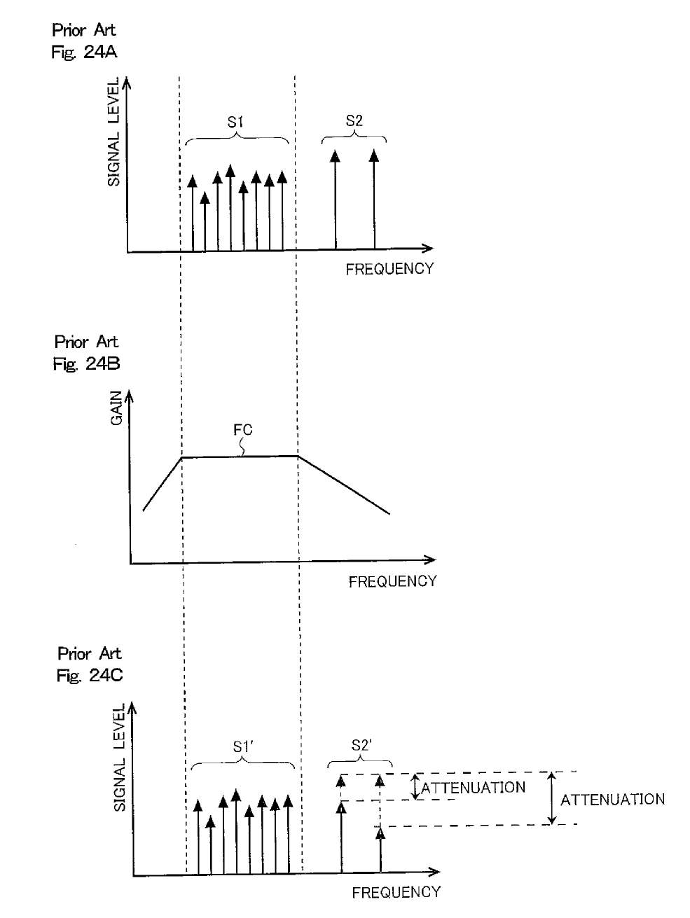

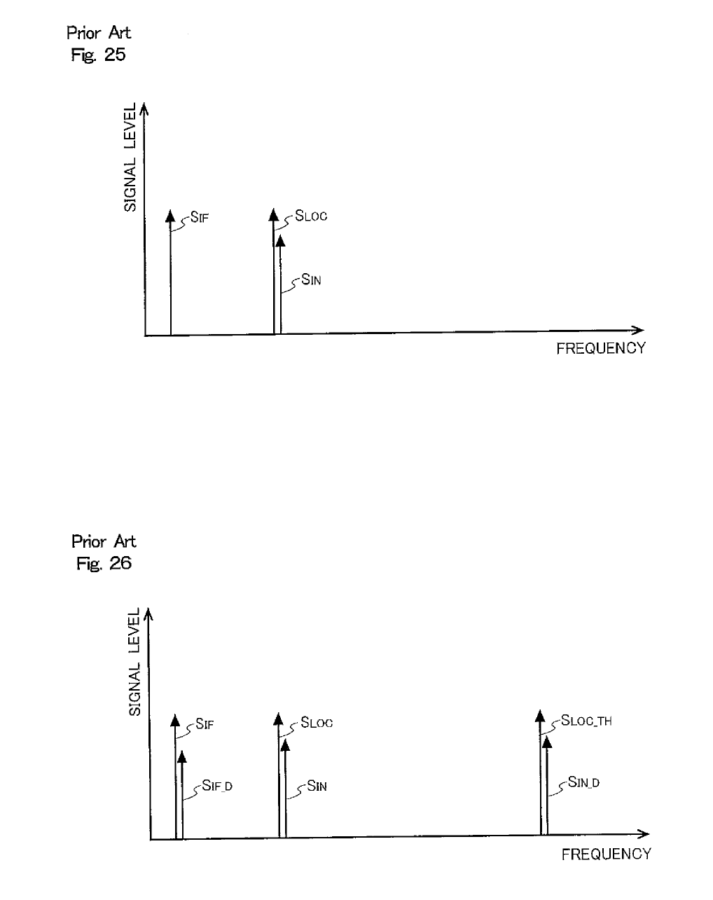

Another specific example of the configuration shown in FIG. 20 is shown in FIG. 22. In FIG. 22, a local oscillation signal generator 4B composed of voltage control oscillators 11A to 11C, a VCO selection circuit 14, a VCO selection switch 15 and the PLL circuit 12 that combines with the voltage control oscillators 11A to 11C and the VCO selection switch 15 to serve as a PLL is used as the local oscillation signal generator 4 (see FIG. 20). The VCO selection circuit 14 controls the VCO selection switch 15 according to, for example, a selection signal inputted from the outside of the tuner section 104 and selects one of the voltage control oscillators 11A to 11C. In FIG. 22, the control circuit 13 is included in the semiconductor integrated circuit device 204, and the control circuit 13 turns on and off each of the field-effect transistors 9A and 10A according to the selection information, outputted from the VCO selection circuit 14, of the voltage control oscillator 4. In a reception apparatus employing the low-IF method or the zero-IF method suitable for a semiconductor integrated circuit, when a reception band (see S1 shown in FIG. 24A and S1′ shown in FIG. 24C) spans a wide band, it is difficult to generate local oscillation signals covering all the area of a reception band with one voltage control oscillator formed in a semiconductor integrated circuit, and thus a plurality of voltage control oscillators are often provided. In FIG. 22, the switch that switches between the effective state and ineffective state of the unnecessary-signal attenuation circuit is controlled according to selection information for the voltage control oscillators which is selected based on the frequency of the desired reception signal. This makes it possible to use the unnecessary-control attenuation circuit appropriately.

Although in the embodiments described above, all the local oscillation signal generator is integrated into the semiconductor integrated circuit, part or all of the local oscillation signal generator may be disposed outside the semiconductor integrated circuit.

What is claimed is:

1. A reception apparatus comprising:
a semiconductor integrated circuit device; and
a fixed band-pass filter provided in a stage preceding the semiconductor integrated circuit device,
wherein the semiconductor integrated circuit device comprises:
a frequency converter;
a to-be-frequency-converted-signal transmission line through which a to-be-frequency-converted signal is fed to the frequency converter;
a local-oscillation-signal transmission line through which a local oscillation signal is fed to the frequency converter; and
at least one of a first unnecessary-signal attenuation circuit, provided in the to-be-frequency-converted-signal transmission line, that attenuates an unnecessary signal included in signals transmitted through the to-be-frequency-converted-signal transmission line and a second unnecessary-signal attenuation circuit, provided in the local-oscillation-signal transmission line, that attenuates an unnecessary signal included in signals transmitted through the local-oscillation-signal transmission line.

2. The reception apparatus of claim 1,
wherein the first unnecessary-signal attenuation circuit and/or the second unnecessary-signal attenuation circuit is a low-pass filter composed of a resistor and a capacitor.

3. The reception apparatus of claim 1,
wherein the first unnecessary-signal attenuation circuit is a capacitor having one end thereof connected to the to-be-frequency-converted-signal transmission line and the other end thereof grounded so as to form a shunt, and/or the second unnecessary-signal attenuation circuit is a capacitor having one end thereof connected to the local-oscillation-signal transmission line and the other end thereof grounded so as to form a shunt.

4. The reception apparatus of claim 1,
wherein the first unnecessary-signal attenuation circuit and/or the second unnecessary-signal attenuation circuit includes an inductor and a capacitor.

5. The reception apparatus of claim 2,
wherein the capacitor is a variable capacitor.

6. The reception apparatus of claim 3,
wherein the capacitor is a variable capacitor.

7. The reception apparatus of claim 4,
wherein the capacitor is a variable capacitor.

8. The reception apparatus of claim 5, further comprising
a capacitance control circuit controlling a capacitance of the variable capacitor.

9. The reception apparatus of claim 6, further comprising
a capacitance control circuit controlling a capacitance of the variable capacitor.

10. The reception apparatus of claim 7, further comprising
a capacitance control circuit controlling a capacitance of the variable capacitor.

11. The reception apparatus of claim 1, further comprising
at least one of a first switch switching between an effective state and an ineffective state of the first unnecessary-signal attenuation circuit and a second switch switching between an effective state and an ineffective state of the second unnecessary-signal attenuation circuit.

12. The reception apparatus of claim 11,
wherein the first switch and/or the second switch is a metal-oxide semiconductor field-effect transistor.

13. The reception apparatus of claim 11,
wherein the first unnecessary-signal attenuation circuit switches to the effective state with the first switch when a frequency of the to-be-frequency-converted signal is low and switches to the ineffective state with the first switch when the frequency of the to-be-frequency-converted signal is high,
and/or the second unnecessary-signal attenuation circuit switches to the effective state with the second switch when a frequency of the local oscillation signal is low and switches to the ineffective state with the second switch when the frequency of the local oscillation signal is high.

14. The reception apparatus of claim 11, further comprising
a local oscillation signal generator generating a local oscillation signal transmitted through the local-oscillation-signal transmission line,
wherein the local oscillation signal generator comprises a voltage control oscillator varying an oscillation frequency according to a frequency of a desired reception signal that is the to-be-frequency-converted signal transmitted through the to-be-frequency-converted-signal transmission line and the first switch and/or the second switch is controlled according to a frequency control voltage of the voltage control oscillator.

15. The reception apparatus of claim 11, further comprising
a local oscillation signal generator generating a local oscillation signal transmitted through the local-oscillation-signal transmission line,
wherein the local oscillation signal generator comprises a plurality of voltage control oscillators and a selection circuit selecting one of the plurality of voltage control oscillators according to a frequency of a desired reception signal that is the to-be-frequency-converted signal transmitted through the to-be-frequency-converted-signal transmission line, the voltage control oscillator selected by the selection circuit generates an oscillating signal corresponding to the frequency of the desired reception signal and outputs the oscillating signal as the local oscillation signal and the first switch and/or the second switch is controlled according to selection of the voltage control oscillators by the selection circuit.
